(19) United States
(12) Patent Application Publication
(10) Pub. No.: US 2006/0216677 A1
(43) Pub. Date: Sep. 28, 2006

(54) Child's writing implement package

(76) Inventor: Nina F. Grosso, Colts Neck, NJ (US)

Correspondence Address: Charles I. Brodsky, 2 Buscks Lane, Marlboro, NJ, 07746, US

(21) Appl. No.: 11/074,486

(22) Filed: Mar. 9, 2005

(51) Int. Cl. G09B 11/00

(52) U.S. Cl. 434/162

(57) ABSTRACT

An openable package containing at least one pencil or pen ergonomically constructed as to length and/or thickness to comfortably fit between the fingers of a young child's hand as a writing implement.

### CROSS-REFERENCE TO RELATED APPLICATIONS

None

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to such writing implements as pens and pencils and, more particularly, to such writing implements as intended for use by young children.

2. Description of the Related Art

As will be appreciated, one of the most memorable events of a parent's life is the day his or her child first boards a school bus to be transported to a learning facility. Also quite memorable are the many days and evenings spent by the parent in trying to assist the child in tracing letters and numbers in learning to write. Perhaps this may be a reason why the teaching of nursery school aged, kindergarten, and first grade school children is such a revered profession. In fact, a great number of adults even today remember the name of their kindergarten and first grade teachers, while forgetting who their teachers were in later grades.

### SUMMARY OF THE INVENTION

Through personal evaluation and analysis upon speaking to teachers of young children, I have determined that a great deal of the difficulty in teaching a child to write follows from the fact that oversized writing implements are used exclusively in these training processes. In particular, I have determined that the pencils and pens of modern day manufacture are by-and-large characteristically made of one standard size, for use by adults. In accordance with my invention, these writing implements are, instead, ergonomically constructed at least to one of their lengths and thicknesses so as to comfortably fit between the fingers of a child's hand. Also in accordance with the invention, so as to be advantageously marketed, these writing implements are included in an openable package, which bears a written notation identifying its contents as being intended for use by a child not exceeding seven years of age. Through analysis following many discussions with these teachers, my invention would appear particularly suitable when the package arrangement is advertised for store sale, with the written notations of the pen and/or pencil contents as being intended for use by a child of ages two-to-six.

In a preferred embodiment of the invention, the package arrangement contains a plurality of these pencils and/or pens, each of which is ergonomically constructed to comfortably fit between the fingers of the child's hand. So as to afford maximum protection in their learning and usage, the package of the invention additionally bears a written notation identifying its contents as not being intended for use without adult supervision. To facilitate an ability to manipulate the pencil or pen in the tracing of letters and numbers, and as a step in the learn-to-write process, the length of these writing implements are substantially 4 inches; at the same time, they are of a thickness of at least ⅜ inches, and preferably 7/16 inches. In order to provide the greatest degree of protection possible, the pencils are non-sharpenable to a point, and the inks dispensed by the pens would be non-toxic. Felt-tipped pens are desirable in this respect—and I have determined that favorable displays for marketing and sale of this package arrangement follows the packaging of 6 such pencils and/or pens, while acknowledging that different numbers of them may be included in any such configuration. Through analysis and conversations with many teachers, it has been determined that a packaging of these types for use by nursery school aged, kindergarten and first grade school children would present great appeal to their parents in purchasing such items for school-time use.

### BRIEF DESCRIPTION OF THE DRAWINGS

These and other features of the present invention will be more clearly understood from a consideration of the following description, taken in connection with the accompanying Drawings, in which:

FIGS. 1a and 1b respectively illustrate the holding for writing of a pencil and pen by an adult;

FIGS. 2a and 2b respectively illustrate the similar holding of the pencil and pen of the invention for writing by a child of an age not exceeding seven years; and

FIG. 3 is an illustration of an openable package embodying the teachings of this invention.

### DETAILED DESCRIPTION OF THE INVENTION

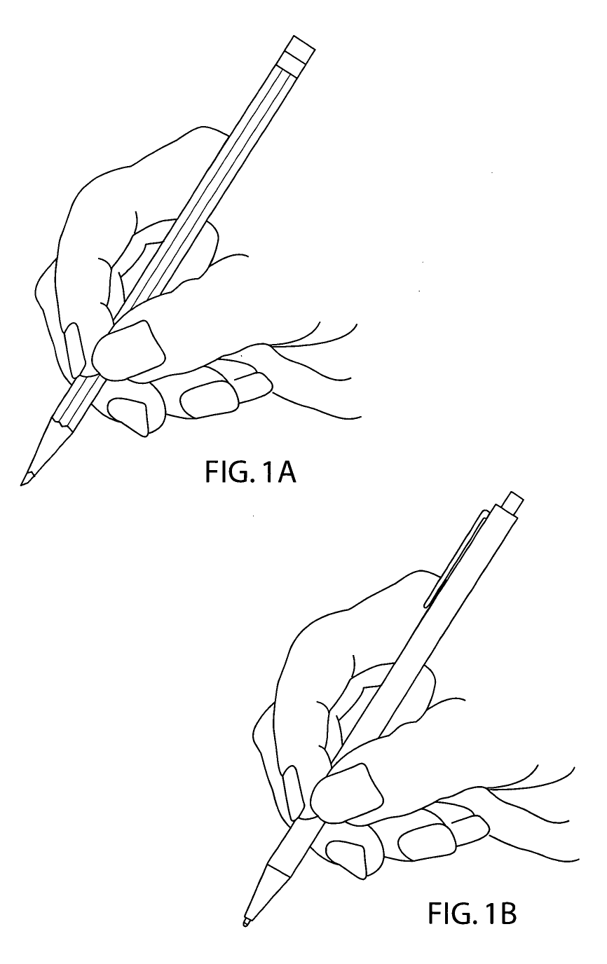

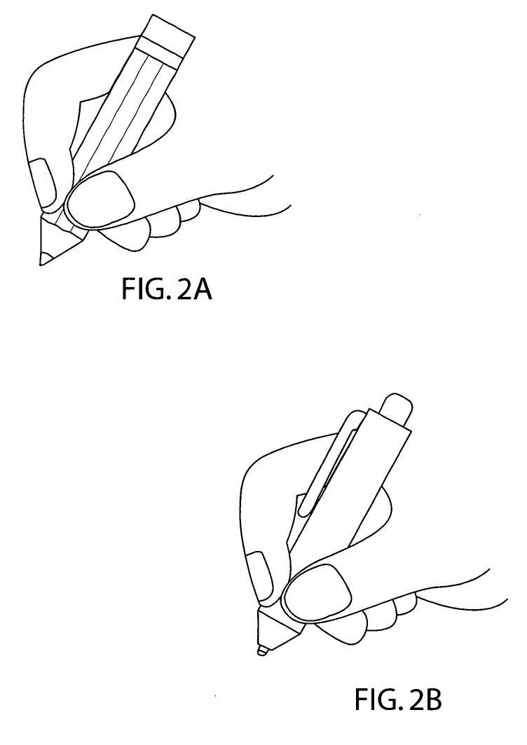

FIGS. 1a and 1b typically show the holding of a pencil 10 and pen 12 between the fingers of an adult's hand 14. Recognizing the oversized nature of these implements for the smaller hand of a child (shown as 16 in FIGS. 2a and 2b), the pencil 18 and pen 20 of the invention are shown as being of both shorter length and greater thickness—although, in accordance with the invention, determination has been made that a comfortable fitting between the fingers of the child's hand and an increased ability to utilize the pencil 18 and pen 20 in writing follows from the ergonomic construction of at least one of the length and thickness, as an alternative to both. In this respect, the shortened pencil 18 and pen 20, as compared to that of the pencil 10 and pen 12 made be a length of between 3¼ and 4¼ inches, as compared to the typical 7-8 inches when of “adult” size (as in FIGS. 1a and 1b). As to “thickness”, the pencil 18 and pen 20 of FIGS. 2a and 2b are at least ⅜ inches thick as compared with “adult” thicknesses for pencil 10 and pen 12 of FIGS. 1a and 1b of 5/16 inches—and preferably 7/16 inches thick.

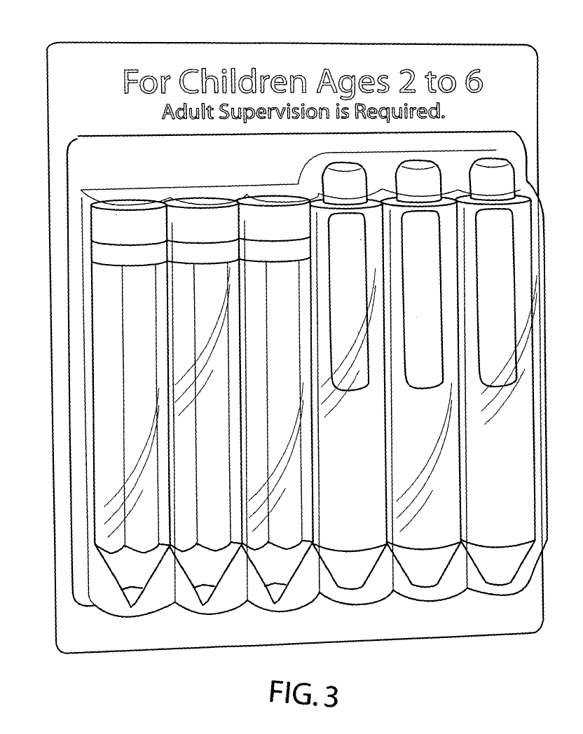

The pencil 18 and pen 20 of FIGS. 2a and 2b are, in accordance with the invention, enclosed within an openable package 22 (FIG. 3) which bears a written notation 24 along a header 26 that the writing implement contents of the package 22 are intended for use by a child not exceeding the age of seven years. As a child of that age is usually already in school, a preferable form of notation 24 might be that the writing implements are intended for use by a child of the age two-to-six years, as it is at that time that the child is first being taught to write. In such manner, packages of these types may be displayed for sale typically in a supermarket or like store where a parent walks up and down the aisles in making their grocery or other purchases. In a further aspect of the invention, such packaging arrangements usually would include pluralities of these pencils and pens for common display and sale, with each being ergonomically constructed to comfortably fit with the size of a child's hand.

Recognizing that safety is of utmost importance with children of such young age, the notation 24 along the header 26 also, according to the invention, carries the notation that the contents of the package 22 are not intended for use without adult supervision. To limit any ability of the pencils to cause injury to a child user, their points, according to the invention, are non-sharpenable. As to the pens, the inks that they dispense are to be non-toxic and easily washed away. Felt-tip pens in this regard are also to be preferred.

Testings of roughly constructed prototype pencils and pens in these manners have been found to be more easily graspable and controllable by both pre-schoolage children and by those in kindergarten and first grade, whose smaller hands are better able to utilize them in both learning the writing process and in carrying out their classroom writing activities. The appeal of these ergonomically constructed writing implements in the advertising display package of the invention has received innumerable compliments from both parents and teachers alike.

While there have been described what are considered to be preferred embodiments of the present invention, it will be readily apparent to those skilled in the art that modifications can be made without departing from the scope of the teachings herein. For example, while the present invention has been described in the context of assisting a child in the learning of writing letters and/or numbers, the invention also has utilization in the more general application of assisting a young child in the grasping of these and similar such implements in expanding upon their abilities to create other writings in drawing, scribbling and generally creating upon paper. For at least such reason, therefore, resort should be had to the claims appended hereto for a true understanding of the scope of the invention.

I claim:

1. The combination comprising:
an openable package;
at least one of a pencil and pen within said package, ergonomically constructed at least to one of a length and thickness to comfortably fit between the fingers of a child's hand as a writing implement;
and with said package bearing a written notation identifying its contents as being intended for use by a child not exceeding the age of 7 years.

2. The combination of claim 1 wherein said package bears a written notation of its contents being intended for use by a child of the age 2 years through 6 years.

3. The combination of claim 1 wherein said package contains a plurality of pencils and/or pens, each of which is ergonomically constructed to comfortably fit between the fingers of a child's hand as a writing implement.

4. The combination of claim 3 wherein said package also bears a written notation identifying its contents as not to be intended for use without adult supervision.

5. The combination of claim 3 wherein each of said pencils and pens is of a length of between 3¼ and 4¼ inches.

6. The combination of claim 3 wherein each of said pencils and pens is of a thickness of at least ⅜ inches.

7. The combination of claim 3 wherein each of said pencils is non-sharpenable.

8. The combination of claim 4 wherein said package contains six pencils.

9. The combination of claim 4 wherein said package contains six pens.

10. The combination of claim 4 wherein said package contains six felt-tipped pens.

11. The combination of claim 10 wherein each of said felt-tipped pens dispense a non-toxic ink upon use.
